(19) United States
(12) Patent Application Publication
(10) Pub. No.: US 2011/0018417 A1
(43) Pub. Date: Jan. 27, 2011

(54) LED LIGHT FIXTURE HAVING HEAT DISSIPATION STRUCTURES

(75) Inventors: CHIH-MING LAI, Chu-Nan (TW); YU-PIN LIU, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/732,203

(22) Filed: Mar. 26, 2010

(30) Foreign Application Priority Data
Jul. 21, 2009 (CN) 200910304622.2

(51) Int. Cl. H01J 61/52

(52) U.S. Cl. 313/46

(57) ABSTRACT

An LED light fixture includes an inner shell containing a cooling fluid therein, an outer shell enclosing the inner shell, a heat conductor extending through the inner and outer shells, a light module mounted on one end of the heat conductor, and a lamp base connected to an opposite end of the heat conductor.

### BACKGROUND

1. Technical Field

The present disclosure relates generally to a light fixture, and more particularly to a light fixture for use with solid state light emitters, e.g., light emitting diodes (LEDs), which can have better heat dissipation.

2. Description of Related Art

LED lamps, a solid-state lighting, utilize LEDs as a source of illumination, providing advantages such as resistance to shock and nearly limitless lifetime under specific conditions. Thus, the LED lamps present a cost-effective yet high quality replacement for incandescent and fluorescent lamps.

However, a lot of heat is generated during the work of the LED lamp, which, if not adequately addressed, impacts the reliability of the LED lamp.

What is needed therefore is an LED light fixture with good heat dissipation capability.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of an LED light fixture in accordance with a first embodiment of the present disclosure.

FIG. 2 is a cross-sectional view of the LED light fixture in FIG. 1, taken along line II-II thereof.

FIG. 3 is an isometric, assembled view of an LED light fixture in accordance with a second embodiment of the present disclosure.

FIG. 4 is a cross-sectional view of the LED light fixture in FIG. 3, taken along line IV-IV thereof.

FIG. 5 is a cross-sectional view of an LED light fixture in accordance with a third embodiment of the present disclosure.

### DETAILED DESCRIPTION

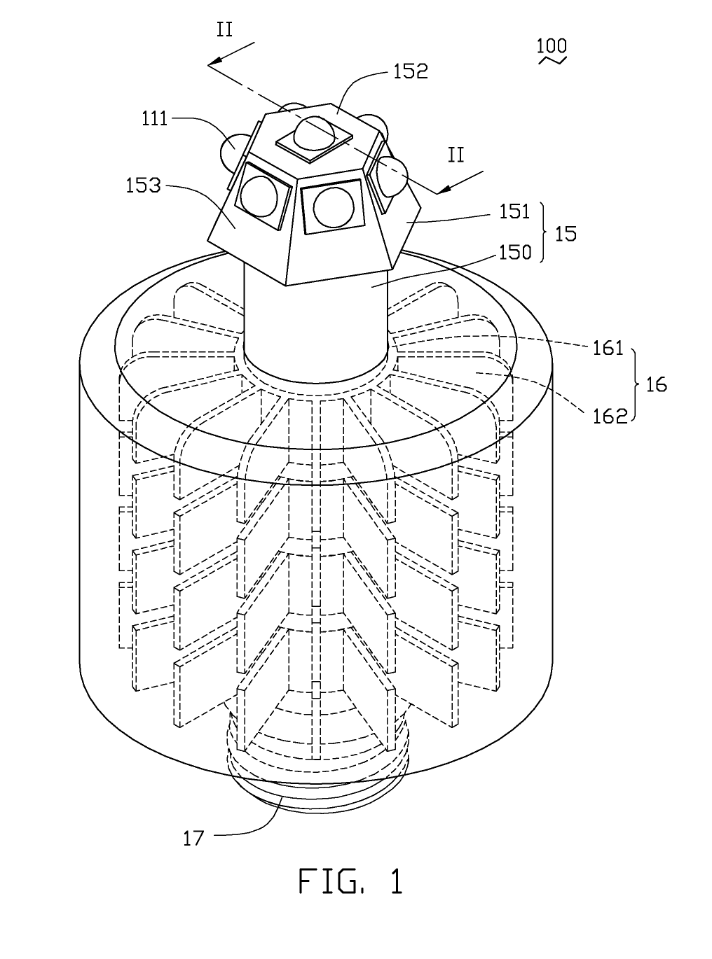

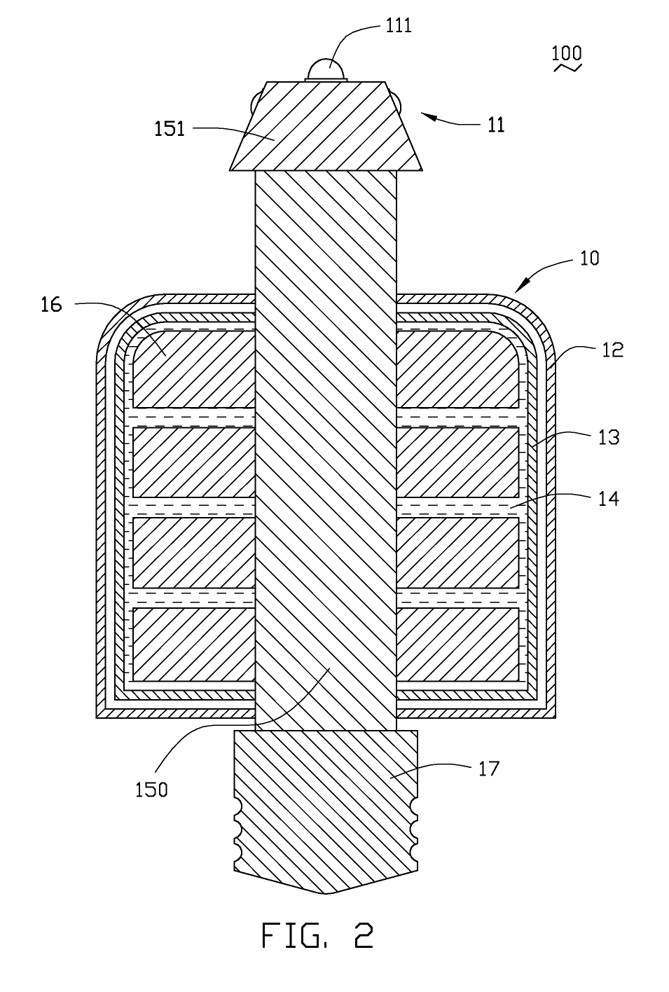

As shown in FIGS. 1-2, an LED light fixture 100 in accordance with a first embodiment of the present disclosure comprises a heat dissipating unit 10, a light module 11 mounted on a top of the heat dissipating unit 10 and a lamp base 17 connecting to a bottom of the heat dissipating unit 10.

The heat dissipating unit 10 comprises an outer shell 12, an inner shell 13 received in the outer shell 12, a heat conductor 15 inserted in and extending through the outer and inner shells 12, 13, and a plurality of fin units 16 received in the inner shell 13 and mounted on the heat conductor 15. A cooling fluid 14 is contained in the inner shell 13. The cooling fluid 14 can be any liquid which has a good thermal capacity, and also a high burning point and a low electric conductivity, in case of electric leakage or spontaneous combustion. The cooling fluid 14 also can be a non-combustible liquid such as water.

The outer and inner shells 12, 13 both have a columned configuration. The inner shell 13 is sealed to contain the cooling fluid 14 therein. The inner shell 13 is spaced from the outer shell 12.

The heat conductor 15 comprises a columned connecting portion 150 and a mounting portion 151. The mounting portion 151 has a configuration of a truncated hexagonal pyramid. It is understood that the mounting portion 151 can be other configurations in alternative embodiments. The connecting portion 150 inserts into the inner and outer shells 12, 13. A bottom of the connecting portion 150 extends through a bottom of the outer shell 12 to connect to the lamp base 17. A top of the connecting portion 150 extends through a top of the outer shell 12 to connect to a bottom end of the mounting portion 151. The mounting portion 151 has a top surface 152 at a top end thereof and six lateral surfaces 153 extending downwardly and outwardly from a hexagonal edge of the top surface 152. The light module 11 is mounted on the mounting portion 151. The bottom end of the mounting portion 151 is larger than the top end of the mounting portion 151.

The fin units 16 are together connected to a circumferential periphery of a central sleeve 161 and each fin unit 16 includes a plurality of plate-shaped fins 162 which are aligned with each other along a central axis of the connecting portion 150. The sleeve 161 is mounted on the connecting portion 150. The plate-shaped fins 162 extend radially and outwardly from the sleeve 161. Understandably, the fins 162 can be integrally formed with the connecting portion 150 and directly extend from the connecting portion 150 in alternative embodiments. The fins 162 each have a substantially rectangular shape. The fin units 16 are equidistantly spaced from each other.

The light module 11 comprises a plurality of light emitting elements 111 mounted on the top and lateral surfaces 152, 153 of the mounting portion 151 of the heat conductor 15. The light emitting elements 111 are light emitting diodes (LEDs).

The lamp base 17 can be a standard lamp holder to connect to a lamp socket (not shown) to provide electrical power for the LED light fixture, when the LED light fixture is used indoors such as in a room. The lamp base 17 can also be a fixing element to connect with a supporting base when the LED light fixture is used outdoors. In this embodiment, the lamp base 17 is a standard screw holder.

The light module 11 can be electrically connected to the lamp base 17 by wires (not shown) through the space between the inner and outer shells 13, 12. The light module 11 can also be electrically connected to the lamp base 17 by wires through a hole (not shown) defined in the heat conductor 15. When the LED light fixture is in work, the heat generated by the light emitting elements 111 is transferred to the connecting portion 150. Since the fin units 16 are mounted on the connecting portion 150, and the fin units 16 and the part of the connecting portion 150 received in the inner shell 13 are immersed in the cooling fluid 14 which has better heat-absorbing capacity than air, heat conducted to the connecting portion 150 can be efficiently dissipated.

The cooling fluid 14 is contained in the sealed inner shell 13. The inner shell 13 is enclosed by the outer shell 12 to further prevent the cooling fluid 14 from leaking out in case that the inner shell 13 is broken. In addition, the outer shell 12 can be easily replaced by a new one if needed.

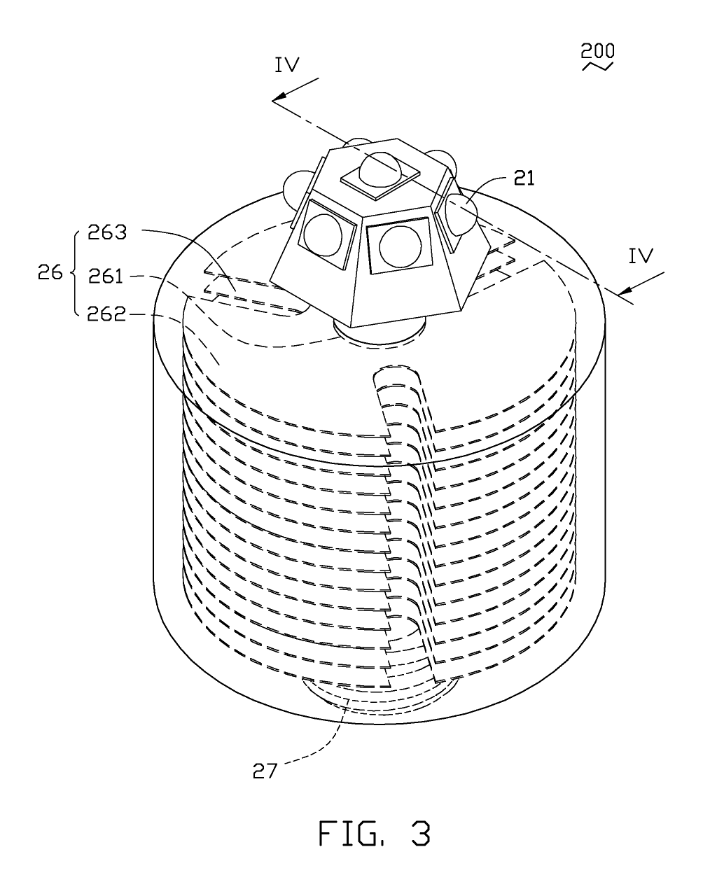

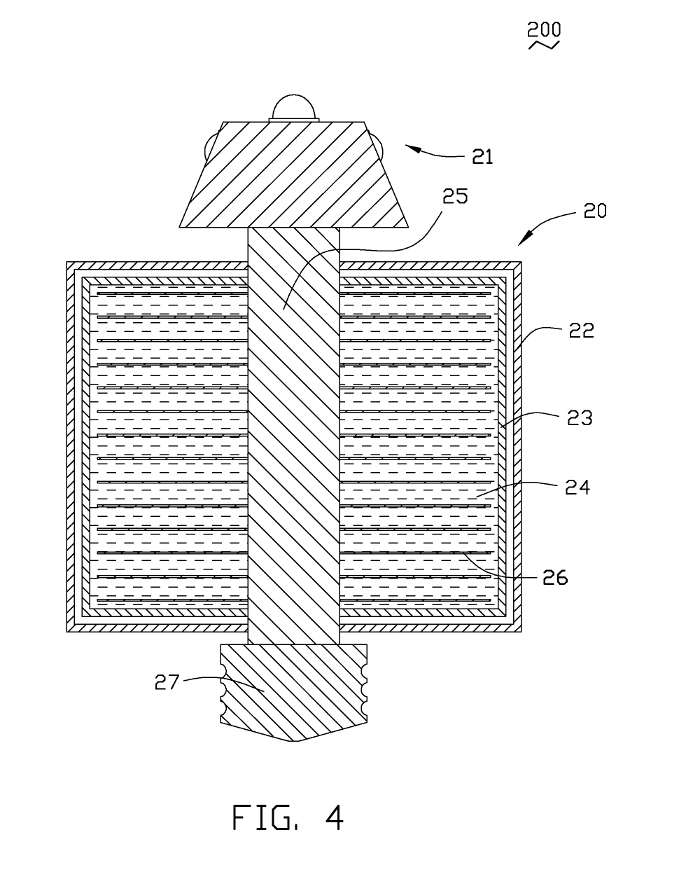

FIGS. 3 and 4 illustrate an LED light fixture 200 in accordance with a second embodiment of the present enclosure. Similar to the LED light fixture 100, the LED light fixture 200 comprises a heat dissipating unit 20, a light module 21 mounted on the heat dissipating unit 20 and a lamp base 27 connecting to the heat dissipating unit 20. The heat dissipating unit 20 also comprises an outer shell 22, an inner shell 23 received in the outer shell 22, a cooling fluid 24 contained in the inner shell 23, a heat conductor 25 inserted into and extending through the outer and inner shells 22, 23, and a plurality of fin units 26 received in the inner shell 23 and mounted on the heat conductor 25.

The fin units 26 are together connected to a sleeve 261 which is mounted on the heat conductor 25. Each fin unit 26 includes a round fin 262 extending outwardly from the sleeve 261. The fins 262 are parallel to each other and perpendicular to a central axis of the heat conductor 25. Three notches 263 are defined in outer edge of the fin 262 and extend along a radial direction in respect to the central axis of the heat conductor 25.

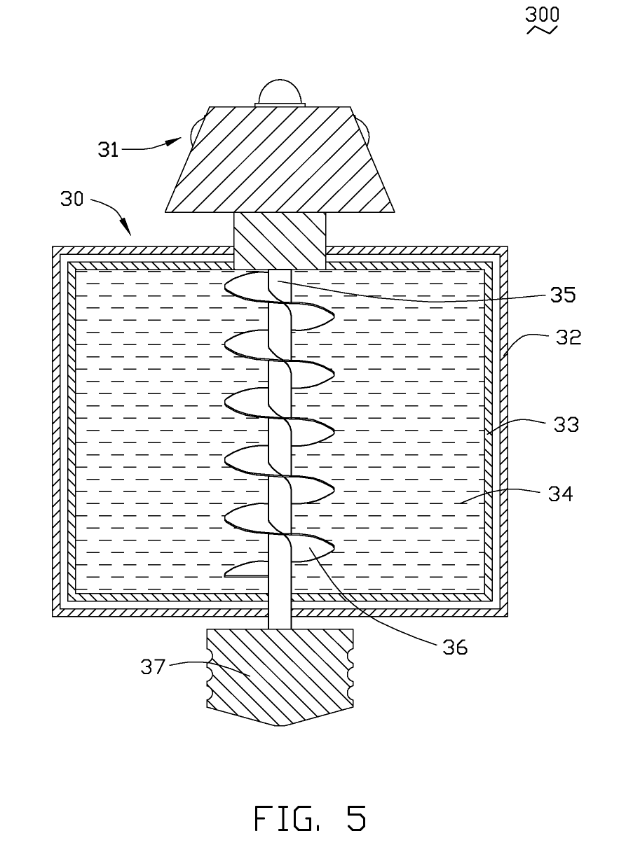

FIG. 5 illustrates an LED light fixture 300 in accordance with a third embodiment of the present enclosure. The LED light fixture 300 is similar to the LED light fixtures 100, 200 in the previous embodiments and comprises a heat dissipating unit 30, a light module 31 mounted on the heat dissipating unit 30 and a lamp base 37 connecting the heat dissipating unit 30. The heat dissipating unit 30 comprises an outer shell 32, an inner shell 33 received in the outer shell 32, a cooling fluid 34 contained in the inner shell 33, a heat conductor 35 inserted in and extending through the outer and inner shells 32, 33, and a fin unit 36 received in the inner shell 33 and mounted on the heat conductor 35. The difference between this embodiment and the previous embodiments is that the fin unit 36 has a helical shape. Further, the fin unit 36 is rotatably mounted on the heat conductor 35. Thus, the fin unit 36 can be driven to rotate to stir the cooling fluid 34 to accelerate heat dissipation.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An LED light fixture comprising:
an inner shell containing a cooling fluid therein;
an outer shell enclosing the inner shell;
a heat conductor comprising a connecting portion extending through the inner and outer shells, and a mounting portion formed on a top of the connecting portion;
a light module mounted on the mounting portion; and
a lamp base connected to a bottom of the connecting portion.

2. The LED light fixture of claim 1, further comprising a fin unit formed in the inner shell and mounted on the connecting portion of the heat conductor.

3. The LED light fixture of claim 2, wherein the connecting portion has a columned shape, and the fin unit comprises a sleeve mounted on the connecting portion and a plurality of fins extending from the sleeve, the fins being aligned with each other along a central axis of the connecting portion.

4. The LED light fixture of claim 2, wherein the connecting portion has a columned shape, and the fin unit comprises a sleeve mounted on the connecting portion and a round fin extending from the sleeve and being perpendicular to a central axis of the connecting portion, the fin defining a plurality of notches therein.

5. The LED light fixture of claim 2, wherein the fin unit has a helical shape.

6. The LED light fixture of claim 5, wherein the fin unit is rotatably mounted on the connecting portion.

7. The LED light fixture of claim 1, wherein the mounting portion has a configuration of a truncated pyramid, with a bottom larger end thereof connecting the connecting portion.

8. The LED light fixture of claim 7, wherein the light module is mounted on top and lateral surfaces of the mounting portion.

9. The LED light fixture of claim 1, wherein the light module comprises at least one light emitting diode.

10. The LED light fixture of claim 1, wherein the inner shell is spaced from the outer shell for wires extending therethrough to connect to the light module and the lamp base.

11. The LED light fixture of claim 10, wherein the lamp base is a standard lamp holder.

12. An LED light fixture comprising:
an inner shell containing a cooling fluid therein;
an outer shell enclosing the inner shell and spaced from the inner shell;
a heat conductor comprising a connecting portion extending through the inner and outer shells, and a mounting portion formed on a top of the connecting portion;
a plurality of light emitting diodes mounted on top and lateral surfaces of the mounting portion; and
a lamp holder connected to a bottom of the connecting portion.

13. The LED light fixture of claim 12, wherein the mounting portion has a configuration of a truncated pyramid with a larger bottom end connected to the connecting portion.

14. The LED light fixture of claim 12, further comprising at least one fin unit mounted on the connecting portion and immersed in the cooling fluid.

15. The LED light fixture of claim 14, wherein the at least one fin unit is rotatably mounted on the connecting portion.
